(19) United States
(12) Patent Application Publication
(10) Pub. No.: US 2026/0172238 A9
(43) Pub. Date: Jun. 18, 2026

(54) Multimodal Cryptographic System, Computer Executable Instructions and Method

(71) Applicant: evolutionQ Inc., Waterloo (CA)

(72) Inventors: Martin LEUNER, Aachen (DE); Patrick REINELT, Aachen (DE); Michele MOSCA, Kitchener (CA); Thorsten Heiner GRÖTKER, Aachen (DE); David Yen JAO, Waterloo (CA)

(73) Assignee: evolutionQ Inc., Waterloo (CA)

(21) Appl. No.: 19/215,826

(22) Filed: May 22, 2025

Related U.S. Application Data
(63) Continuation of application No. PCT/CA2024/050190, filed on Feb. 15, 2024.
(60) Provisional application No. 63/485,050, filed on Feb. 15, 2023.
(60) Provisional application No. 63/519,945, filed on Aug. 16, 2023.

(51) Int. Cl. H04L 9/08

(52) U.S. Cl. CPC H04L 9/085; H04L 9/0819; H04L 9/0852

(57) ABSTRACT

A method, system and computer readable medium for establishment of cryptographic secrets is disclosed. Illustratively, the method includes obtaining a first input share based on a hybrid key establishment method, obtaining a second input share from a key distribution network, and deriving, from the first input share and the second input share, a shared secret for use in cryptographic communication between an initiator and a respondent.

### CROSS REFERENCE TO RELATED APPLICATIONS

This application is a Continuation of PCT Patent Application No. PCT/CA2024/050190, filed on Feb. 15, 2024, which claims priority to U.S. Provisional Patent Application No. 63/485,050 filed on Feb. 15, 2023, and U.S. Provisional Patent Application No. 63/519,945, filed on Aug. 16, 2023, the contents of which are incorporated herein by reference in their entirety.

### TECHNICAL FIELD

The following generally relates to cryptographic communications and, more particularly, to cryptographic protocols to establish end-to-end (E2E) secrets.

### BACKGROUND

Delivering encryption keys, including strong E2E encryption keys, to a large number of endpoints is challenging. The threat of quantum computers being able to break widely deployed classical asymmetric cryptography has also increasingly become a concern.

State-of-the-art solutions include the following approaches: pre-shared keys (PSKs), key distribution centers (KDCs), and public-key infrastructures (PKI). Lately, post-quantum cryptography (PQC) approaches have emerged, either standalone or in a hybrid fashion, i.e., combined with tried-and-tested classical asymmetric cryptography.

### Pre-Shared Keys

Pre-sharing is likely the oldest approach to distributing encryption keys. Keys or key shares can be delivered by trusted couriers which, depending on the circumstances, may have to be subject to substantial physical security measures. In some critical infrastructures, such as finance or certain military applications, this approach is still currently being heavily relied upon. PSKs are found to not scale, though, as the number of keys grows quadratically with the number of endpoints. Trustworthiness, reliability, cost, and the speed of couriers are additional issues. This led to a quest for automation, with KDCs being the first major step.

### Key Distribution Centers

The advent of KDCs significantly improved scalability. Now, endpoints essentially only need a single (set of) pre-shared secret(s) which are used for authentication and encryption when communicating with a trusted (and, hopefully, trustworthy) KDC that facilitates E2E key generation and distribution. KDCs can be federated, with different entities serving different sets of endpoints.

The majority of widely deployed KDCs rely exclusively on symmetric cryptography, which is robust (even if attackers are equipped with powerful quantum computers, as long as key sizes are sufficiently large a breach is unlikely) and imposes only minimal performance and capacity requirements on the endpoints. The main caveat is that a compromise of a KDC is expected to have catastrophic consequences. Namely, in such a compromise, attackers are able to decrypt present, future, and sometimes also past E2E communication between endpoints, and they can also impersonate endpoints.

A prominent example of a KDC is Kerberos. However, Kerberos does not offer forward secrecy; its designers focused on authentication as a primary use case and tried to avoid further complicating the protocol, which already has a lot of moving parts (and, hence, attack surface) and, in addition, imposes strict requirements on time synchronization of the parties involved.

The use of asymmetric cryptography in the context of a PKI was expected to solve such KDC-related problems.

### Public-Key Infrastructure

Asymmetric cryptography addresses some of the open issues via key establishment mechanisms such as Diffie-Hellman as well as through key encapsulation mechanisms (KEMs) that do not depend upon (pre-) shared secrets. In addition, public-key cryptography promises authentication techniques that do not require an endpoint to reveal its private keys to anybody. In practice, though, one is faced with a new set of issues.

For instance, endpoints often place trust in certificate authorities (CAs) to validate digital identities, i.e., the association of a public key with a particular entity. If compromised, a malicious CA allows for man-in-the-middle (MIM) attacks whereby an attacker impersonates an endpoint.

Furthermore, experience shows that asymmetric cryptography has been broken time and again for decades. The reasons are manyfold and may include bad choices of algorithms, software vulnerabilities, use of weak keys, and side-channel attacks. Even RSA, which rests on comparatively simple algebraic structures rendering it the world's most well-understood public-key crypto-system, is not immune [1].

### (Paranoid) Post-Quantum Cryptography

The availability of sufficiently powerful quantum computers is expected to lead to all classical asymmetric cryptography becoming insecure. Its replacement, post-quantum cryptography (PQC), is still subject to cryptanalysis. Some promising-looking algorithms have been found to be susceptible to being broken. And, more is yet to come, even if some new algorithms actually do pass the test of time. Their reliance on ever more complex algebraic structures provide a larger attack surface when it comes to implementation errors, side-channel attacks, and keys that looked strong for some years until they turned out to be weak. The fact that the cryptographic community now has to analyze a growing variety of algorithms while attackers have access to new tools such as artificial intelligence (AI) exacerbates the problem.

It may also be noted that asymmetric cryptography cannot be relied upon to establish E2E keys with stringent long-term security requirements, regardless of whether classical or post-quantum cryptography (or a hybrid combination thereof) is used.

Paranoid post-quantum crypto is sometimes portrayed as a solution. It refers to the concurrent use of multiple PQC algorithms. While this offers some temporary relief (one should assume that eventually all real-world PQC implementations will exhibit vulnerabilities), it comes at a huge implementation cost in terms of computational requirements (code size, runtime) and capacity (size of keys and signatures).

### SUMMARY

The following addresses secure and efficient establishment of quantum-resistant long-term security (LTS) E2E cryptographic secrets to endpoints that are not directly connected via a quantum key distribution network (i.e., QKD links, possibly connected via trusted nodes).

A multimodal key delivery network (KDN) protocol is provided, which utilizes different types of symmetric and asymmetric cryptographic algorithms. Rather than hardwiring specific codes or key sizes, the following utilizes a crypto-agile approach that selects the respective parameters from continuously evolving guidelines by well-respected certification schemes such as the National Institute for Standards and Technology's (NIST's) Special Publications SP-800 series and German Bundesamt für Sicherheït in der Informationsverarbeitung's (BSI's) Technische Richtlinien (TRs).

In this context, one should consider the difference between a multimodal KDN protocol implementation in an endpoint and the subsequent use of the E2E key, e.g., for encryption. The latter is relatively straightforward in that all relevant encryption standards and products have interfaces that allow for the injection of PSKs. While PSKs did not solve the given key distribution problem, they can be useful as a modular approach to using E2E keys once established. Encryption devices can directly consume keys established using the proposed technique; they are decoupled from the actual implementation and crypto-agile adaptations of the multimodal KDN protocol.

Moreover, performance and efficiency (e.g., battery life) considerations often lead to high-priority requirements. To account for that, the multimodal KDN protocol can be configured in such a way that it requires only a small number of protocol steps and key material can be pre-generated; an endpoint can connect to the KDN to obtain multiple sets of pre-key data for a given destination endpoint. This can potentially allow for short connection latencies and good burst-mode performance.

In an aspect, a method for cryptographic establishment of shared secrets is disclosed. The method includes obtaining a first input share based on a hybrid key establishment method, obtaining a second input share from a key distribution network, and deriving, from the first input share and the second input share, a shared secret for use in cryptographic communication between an initiator and a respondent.

In example embodiments, obtaining the first input share from the KDN includes requesting, by the initiator, a dataset for establishing communication with the respondent, and receiving a responding dataset from the KDN. The responding dataset includes (1) a base key (i.e., the first input) derived from a pre-existing key secret between the respondent and a hub of the KDN, (2) an update counter and identifiers for the initiator and the hub, and (3) a message authentication code (MAC) authenticating the update counter and the identifiers, wherein the MAC authenticates via a pre-existing authentication secret shared by the respondent and the hub. The pre-existing key secret can be rolled by the respondent, in response to receiving the responding dataset. The request for the dataset transmitted by the initiator can trigger rolling of the pre-existing key secret by the hub.

In example embodiments, the method includes establishing a secure link between the initiator and another hub of the KDN by deriving, by the initiator, an authentication secret based on a pre-existing link secret shared by the other hub and the initiator. The method includes transmitting, by the initiator, at least the identifier of the initiator authenticated using the derived authentication secret, the derived authentication secret being able to validate the authenticated identifier transmitted by the initiator. The method includes receiving and confirming subsequent data from the other hub, the subsequent data being validated with the derived authentication secret and deriving a link key to establish the secure link based on the pre-existing link secret for subsequent communication between the initiator and the other hub. The hub and the other hub can be the same hub of the KDN. The at least the identifier of the initiator can include a nonce, and the subsequent data further comprises a second nonce, and the link key is derived based on the nonce and the second nonce.

The method can include updating the pre-existing link secret in response to the deriving the link key. The updated link secret can be used to establish subsequent secure links.

In example embodiments, the established secure link is used for secure asynchronous communication, and the method further comprises employing secure asynchronous communication based on the derived link key and a message counter.

In example embodiments, the initiator and the respondent are both endpoints, and the method further includes transmitting, by the initiator, pre-key data received from a hub the respondent is associated with, the transmitted pre-key data being processed by the respondent to obtain the first input. The method includes performing the hybrid key establishment method to generate the second input, and validating the first input and the second input. The respondent can be configured to, in processing the pre-key data, to update a secret associated with an update counter for communications between the respondent and the KDN, and compute the first input based on the updated secret.

In example embodiments, the hybrid key establishment method is based on exchanging via both a classical approach and a post-quantum approach. The exchange can include at least two exchanges, and the classical approach and the post-quantum approach exchanges are independent of one another. The method can include combining secrets resulting from the classical approach and the post-quantum approach to form the resulting hybrid shared secret.

In example embodiments, validating the first and second inputs includes deriving a confirmation key from the first input and the second input, and confirming, by the initiator, the validity of a message authentication code received from the respondent, the received message authentication code being generated at least in part with the confirmation key. The method includes transmitting, by the initiator, a message comprising a message authentication code generated at least in part based on the confirmation key to enable the respondent to validate the initiator transmitted message authentication code. The message authentication code can be generated based on outputs of the hybrid key establishment method.

The method can include storing unused first inputs and deleting used first inputs.

In another aspect, a method for associating two entities is disclosed. The method is for deriving shared secrets for use in cryptographic communications between the two entities, and includes based on a common shared base secret, deriving, a key secret, a link secret, and an authentication secret. The link secret can be used to communicate between the entities, and the key secret can be used to introduce a third entity known by at least one of the two entities to the other of the two entities, the key secret for establishing a shared secret between the third entity and the other of the two entities.

In another aspect, a system for cryptographic communications is disclosed. The system includes at least two endpoints and a key distribution network comprising a plurality of key distribution hubs connected to one another, at least one of the endpoints comprising a process and memory. The memory stores computer executable instructions that when executed by the processor cause the endpoint to perform any one of the methods discussed above.

In another aspect, a non-transitory computer readable medium (CRM) is disclosed. The CRM includes computer executable instructions for cryptographic communications, the computer executable instructions when executed by a processor causing the processor to perform any of the above methods.

In another aspect, a data processing apparatus is disclosed. The data processing apparatus includes means for carrying out the any of the above methods.

### BRIEF DESCRIPTION OF THE DRAWINGS

Embodiments will now be described with reference to the appended drawings wherein:

FIG. 1 is a schematic diagram of a key distribution network.

FIG. 2 is a flow chart illustrating operations performed in establishing a secure link with a key distribution hub.

FIG. 3 is a flow chart illustrating operation performed in establishing a session key.

FIG. 4 is a flow chart illustrating a method for cryptographic communication.

### DETAILED DESCRIPTION

As used herein, the term “obtain” can denote a derivation process (e.g., using the discussed hybrid key establishment method), or one or a sequence of transmissions to receive that “obtained information,” (e.g., receiving pre-key data from a key distribution hub).

The following describes a protocol that allows two entities to obtain a common secret which can e.g., be used as a PSK in existing communication equipment.

At present, this is typically done using key establishment mechanisms based on asymmetric cryptography; sometimes using a combination of classical and PQC. While asymmetric cryptography can be used to establish short-lived ephemeral keys, it is not well suited as the root of trust for encryption keys with LTS requirements. On the other hand, KDCs sole reliance on more-robust all-symmetric cryptography bears substantial risks related to forward secrecy (FS) and identity theft when compromised.

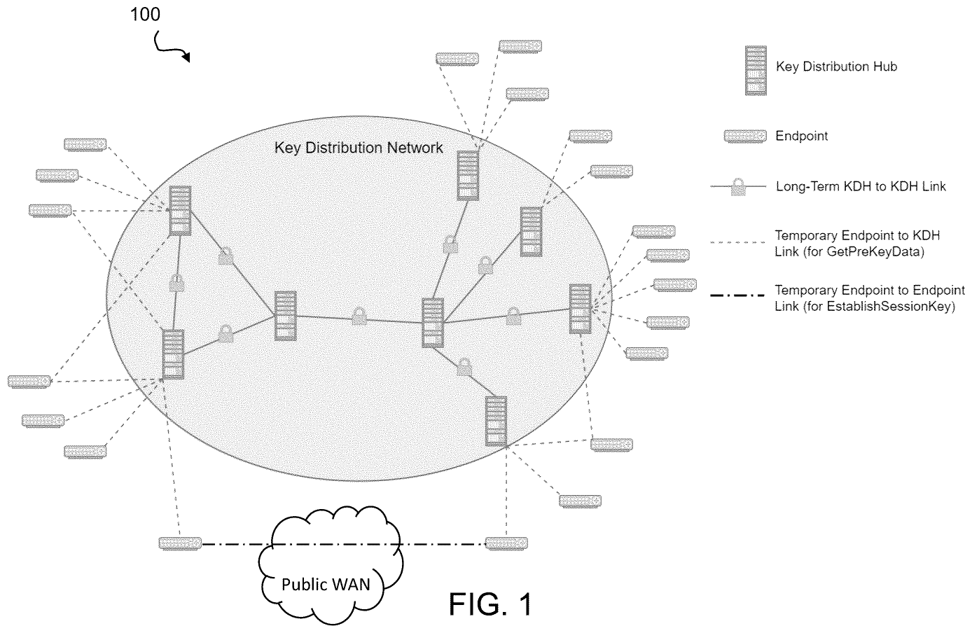

In contrast, this disclosure includes a secret derived from two input shares in the presently described scheme. The first share is exchanged using a quantum-safe hybrid key establishment scheme, i.e., a combination of a classical key establishment and a PQC key establishment. The second share is obtained from a KDN having key distribution hubs (KDHs) connected via point-to-point links that are encrypted with symmetric keys which have been securely delivered out of band, e.g., as shown in FIG. 1. In order to use the KDN, an endpoint needs to associate with a KDH employing a (one time) enrollment procedure. It can be appreciated that the KDN illustrated in FIG. 1 can be applied to various scenarios, for example, without limitation, telecommunications providers with an existing core network and separate access or peripheral network, organizations that operate a core network with high security requirements between major sites and a secondary network between minor sites (e.g., financial institutions, government installations), etc.

After enrollment, an endpoint can connect to the KDN to obtain (sets of) pre-key data for a given destination endpoint. This pre-key data can be cached and subsequently used to establish a common secret between the endpoints without the need for either of them to be connected to the KDN at that point. The pre-key data contains strong secrets that allow the endpoints to establish a secure long-term key without being part of the KDN itself. This makes it particularly suitable for mobile endpoints or ‘last mile’ connections.

The security of the presently described method rests on multiple modes of cryptographic operations that are strongly interwoven and may hereinafter be referred to as “multimodal cryptography”.

Security properties of the proposed protocol include, without limitation:

E2E keys of strong computational security, even if all asymmetric crypto is broken.

Strong computational FS: even if all asymmetric crypto is broken, all endpoints and all KDHs are breached, past sessions are still secure.

Computational-strength post-compromise security (PCS).

Breaching any number of KDHs does not lead to endpoint identity theft.

Here, strong computational security refers to symmetric cryptography whereas the weaker computational security hinges on hybrid asymmetric cryptography, i.e., a combination of classical asymmetric cryptography and PQC.

KDHs can optionally be connected via QKD links. This allows a system to further strengthen the authenticated encryption used to protect key shares in transit.

### Protocol Description

### Notation

One can denote public keys by K, and private keys by k. For symmetric keys one can use κ (for encryption and authentication keys), or S or [symbol] (for key derivation keys).

One can write x←E to denote assigning the result of the expression E to the variable x. One can write x₀, . . . , xₙ [symbol] X to denote choosing values independently at random according to the probability distribution X and assigning them to the variables x₀, . . . , xₙ. If X is a finite set, this notation can be abused to mean choosing random values uniformly from X.

One can use x ||y to denote the concatenation of two bitstrings x and y.

One can also denote a security parameter as n_{sec}. This determines the overall security strength (in bits) of the resulting end-to-end keys.

1.0 Entities

1.1 Key Distribution Hub

The KDHs make up the KDN. New KDHs are added to the KDN using pre-shared secrets delivered out of band. Within the KDN, KDHs can be directly connected to one another, i.e., they hold mutually shared secrets to secure communication with one another. Endpoints can enroll with the KDN, establishing an association, i.e., shared secrets between the endpoint and a KDH. KDHs broadcast the lists of associated endpoints—along with their public keys—to the KDN.

Secrets stored by KDH X can be summarized as follows:
the private key k_{Auth,C} (X) for classical authenticated key establishment;
the private key k_{Auth,PQ}(X) for post-quantum authenticated key establishment;
for each directly connected KDH Y, a shared secret [symbol] _{Link}(X, Y) to enable secure communication; and
for each associated endpoint P:
   a shared secret [symbol] _{Link}(X, P) to enable secure communication;
   a shared secret [symbol] _{Key}(X, P) used in key establishment with other endpoints; and
   a shared secret key κ_{StaticAuth}(X, P) to authenticate messages between X and P.

The public data stored by KDH X can be summarized as follows:
a unique identifier IDₓ;
the public key K_{Auth,C}(X) for classical authenticated key establishment;
the public key K_{Auth,PQ}(X) for post-quantum authenticated key establishment;
for each directly connected KDH Y:
   a unique identifier ID_{Y};
   the KDH's public key K_{Auth,C}(Y) for classical authenticated key establishment;
   the KDH's public key K_{Auth,PQ}(Y) for post-quantum authenticated key

establishment; and
for each associated endpoint P:
   a unique identifier ID_{P};
   an update counter n_{KeySecret}(X, P) for [symbol] _{Key}(X, P);
   the endpoint's public key K_{Auth,C}(P) for classical authenticated key establishment;
   the endpoint's public key K_{Auth,PQ}(P) for post-quantum authenticated key establishment;

1.2 Endpoint

The endpoints are entities which want to establish secure long-term keys with one another using the KDN. Each endpoint needs to associate with at least one KDH initially.

Secrets stored by endpoint P can be summarized as follows:
the private key k_{Auth,C}(P) for classical authenticated key establishment;
the private key k_{Auth,PQ}(P) for post-quantum authenticated key establishment;
for each KDH X with which P is associated:
   a shared secret [symbol] _{Link}(P, X) to enable secure communication;
   a shared secret [symbol] _{Key}(P, X) used in key establishment with other endpoints;
   a set of base keys and their indices,

Dₓ={(i₁, S_{Key,i}_{₁}, (P,X)), (i₂, S_{Key,i}_{₂}(P,X)), . . . },

where the base keys S_{Key,i}(P, X) are derived from previous instances of [symbol] _{Key}(P, X); and

a shared secret key K_{StaticAuth}(P, X) to authenticate messages between P and X.

Public data stored by endpoint P can be summarized as follows:
a unique identifier ID_{P};
the public key K_{Auth,C}(P) for classical authenticated key establishment;
the public key K_{Auth,PQ}(P) for post-quantum authenticated key establishment;
for each KDH X with which P is associated:
   the update counter n_{KeySecret}(P, X) for [symbol] _{Key}(P, X), which can be transmitted in the clear between an initiating and target endpoint;
   the KDH's public key K_{Auth,C}(X) for classical authenticated key

establishment; and

2the KDH's public key K_{Auth, PQ}(X) for post-quantum authenticated key establishment.

### 2.0 Primitives

### 2.1 Hybrid Authenticated Key Exchanges

To perform a two-move authenticated key exchange, let an initiator A call

(X,x)←HybridKexInit(k_{Auth,C}(A), k_{Auth,PQ}(A), K_{Auth,C}(B), K_{Auth,PQ}(B))

After receiving X from A, the responder B calls

(X′, S)←HybridKexResp(k_{Auth,C}(B), k_{Auth,PQ}(B), K_{Auth,C}(A), K_{Auth,PQ}(A), X)

Finally, having received X′, the initiator A calls

S←HybridKexFinalize(k_{Auth,C}(A), k_{Auth,PQ}(A),K_{Auth,C}(B),K_{Auth,PQ}(B), x, X′)

Both parties end up with a shared secret S.

These three hybrid primitives are built from a two-move classical key exchange (InitC, RespC, FinalC) and a two-move post-quantum key exchange (InitPQ, RespPQ, FinalPQ).

The initiator A uses Init* to generate a secret x* and a public value X*, the responder B uses Resp* with X* to obtain the shared secret S* and a public value X′*, then the initiator A uses Final* with X′ and x* to obtain S* as well. Both Resp* and Final* can also return fail in case of authentication failures. In this case, the parties abort the hybrid key exchange.

The parties perform the classical and post-quantum exchanges independent from one another, combining messages to keep the number of roundtrips low. They concatenate the resulting shared secrets to form the hybrid shared secret.

Below is a more detailed discussion of an example exchange of input shares to arrive at a shared secret S:

```
HybridKexInit(k_{Auth, C} (A), k_{Auth, PQ} (A), K_{Auth, C} (B), K_{Auth, PQ} (B)):
  1. Compute
(X_{C}, x_{C}) ← InitC (k_{Auth, C} (A), K_{Auth, C} (B))
  2. and
(X_{PQ}, x_{PQ}) ← InitPQ (k_{Auth, PQ} (A), K_{Auth, PQ} (B)).
  3. Return (X = (X_{C}, X_{PQ}), x = (x_{C}, x_{PQ})).
HybridKexResp(k_{Auth, C} (B), k_{Auth, PQ} (B), K_{Auth, C} (A), K_{Auth, PQ} (A), X):
  4. Parse (X_{C}, X_{PQ}) = X.
  5. Compute
(X′_{C}, S_{C}) ← RespC(k_{Auth, C} (B), K_{Auth, C} (A), X_{C})
  6. and
(X′_{PQ}, S_{PQ}) ← RespPQ(k_{Auth, PQ} (B), K_{Auth, PQ} (A), X_{PQ}).
  7. Return (X′ = (X′_{C}, X′_{PQ}), S = S_{C}∥S_{PQ}).
HybridKexFinalize(k_{Auth, C} (A), k_{Auth, PQ} (A), K_{Auth, C} (B), K_{Auth, PQ} (B), x, X′):
  8. Parse (x_{C}, x_{PQ}) = x and (X′_{C}, X′_{PQ}) = X′.
  9. Compute
S_{C} ← FinalC(k_{Auth, C} (A), K_{Auth, C} (B), x_{C}, X′_{C})
10. and
S_{PQ} ← FinalPQ(k_{Auth, PQ} (A), K_{Auth, PQ} (B), x_{PQ}, X′_{PQ}).
11. Return S = S_{C}∥S_{PQ}.
```

There are several options for concrete instantiations of the classical and the post-quantum key exchanges. For example, for the classical key exchange, one may use any scheme which is eCK-secure [2] in the Random Oracle Model (ROM).

For the post-quantum key exchanges, to provide some examples, one may use any scheme which is eCK-secure against quantum adversaries in the Quantum Random Oracle Model (QROM), or FO_{AKE} [3] applied to a quantum-resistant public key encryption scheme.

### 2.2 Key Derivation

A system incorporating the present protocol can use key derivation functions (KDFs) to create the initial shared secrets in EnrollEndpoint (see section 3.1 below), update the shared secrets and derive other keys from the shared secrets. In each case, one can use high-entropy uniformly distributed base key material. Thus, to provide an example, one may use a simple pseudorandom function family (PRF)-based KDF (such as the ones in [4]) rather than an extract-then-expand construction like HKDF [5,6].

The primitive KDF (k,c) calls an example PRF-based KDF, using k as the base key material, c as the FixedInfo string, and an output size of n_{Sec}. The particular instances of c used hereafter are for illustrative purposes only and may be exchanged without limitation.

To update shared secrets, the protocol can call the KDF:

UpdateSecret(s)=KDF (s, “UpdateSecret”)

### 2.3 Message Authentication and Confidentiality

Subsequent massages between the initiator and recipient can be authenticated with an Authenticated Encryption scheme with Associated Data (AEAD) with security properties described by Rogaway [7]: its ciphertexts can be indistinguishable from random bits under chosen-plaintext attacks, and the integrity tags shall be unforgeable.

One can denote by AEAD (κ, a, x) the primitive which uses this AEAD scheme to encrypt data x using the key κ, with associated data a.

The disclosed protocol, as an example, can fix a Message Authentication Code (MAC) scheme which is strongly existentially unforgeable under chosen-message attacks.

One can denote by MAC (κ, x) the primitive which computes this MAC with key κ over data x.

Potential choices include, without limitation: HMAC [8,9] for the MAC, and AES-GCM [10-12] for the AEAD scheme.

### 3.0 Procedures

### 3.1 EnrollEndpoint

Endpoint P enrolls with the KDN by establishing an association with KDH X. This procedure consists of two steps: secure establishment of a temporary base secret S and the derivation of long-lived shared secrets between P and X from the base secret S. Several options are feasible to establish such a base secret securely. Great care has to be taken to ensure the base secret S is established in a way that meets or exceeds the security requirement of the consumer of the E2E keys established with the multimodal protocol. For example, P and X can use a hybrid key establishment method to establish the base secret S, which can include using a secure link (e.g., at least one of a temporary, and physical link) in the first step.

P computes
(E_{P}, e_{P}) ← HybridKexInit(k_{Auth, C} (P), k_{Auth, PQ} (P), K_{Auth, C} (X), K_{Auth, PQ} (X));
and sends (K_{Auth, C} (P), K_{Auth, PQ} (P), E_{P}) to X.
X computes:
(E_{X}, S) ← HybridKexResp(k_{Auth, C} (X), k_{Auth, PQ} (X), K_{Auth, C} (P), K_{Auth, PQ} (P), E_{P})
and sends (K_{Auth, C} (X), K_{Auth, PQ} (X), E_{X}) to P;
P computes
S ← HybridKexFinalize(k_{Auth, C} (P), k_{Auth, PQ} (P), K_{Auth, C} (X), K_{Auth, PQ} (X), e_{P}, E_{X});

In the second step, P and X derive the long-lived shared secrets in the following way:

[symbol]

_{Link}(P, X)= [symbol] _{Link}(X, P)←KDF(S, “LinkSecret”),

[symbol]

_{Key}(P, X)= [symbol] _{Key}(X, P)←KDF(S, “KeySecret”),

κ_{StaticAuth}(P, X)=κ_{StaticAuth}(X, P)←KDF(S, “StaticAuth”),

and set n_{KeySecret}(P, X)=n_{KeySecret}(X, P)←0. Finally, P sets D_{X}←Ø; and

P and X perform EstablishLink (see section 3.2 below) to confirm the shared secrets just established.

### 3.2 EstablishLink

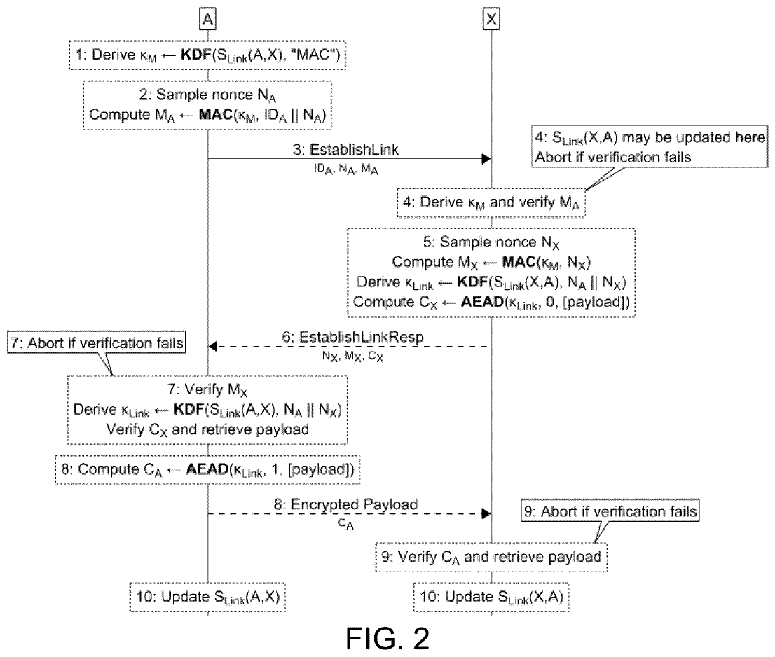

FIG. 2 shows an example method of establishing a link between an initiator and a key distribution hub. More specifically, an initiator A establishes a secure link with KDH X. The initiator A can be either an endpoint P or another KDH. A shares a link secret [symbol] _{Link}(A, X) with X. In the case of an endpoint, this means A previously has associated with X using EnrollEndpoint (see section 3.1 above). In the case of another KDH, shared secrets have been established between them. The following operations are shown in FIG. 2.

1. A derives the MAC key:

κ_{M}←KDF( [symbol] _{Link}(A, X), “MAC”)

2. A samples a nonce N_{A} [symbol] {0,1}ⁿ_{Sec} and computes the MAC:

M_{A}←MAC(κ_{M}, ID_{A}||N_{A})

3. A sends (ID_{A}, N_{A}, M_{A}) to X.

4. X derives the MAC key and verifies the MAC M_{A}. If this fails, it computes a tentatively updated link secret:

S←UpdateSecret( [symbol] _{Link}(X, A))

and recomputes the MAC key using this as the base key. If X can verify M_{A} using the recomputed MAC key, it updates its link secret:

[symbol]

_{Link}(X, A)←S

to resync with A. Otherwise, it aborts the procedure.

5. X initializes the link's sequence counter s←0, samples a nonce N_{X} [symbol] {0,1}ⁿ_{Sec} and computes the MAC, link key, and ciphertext:

M_{X}←MAC(κ_{M}, N_{X})

κ_{Link}KDF( [symbol] _{Link}(X, A), N_{A}||N_{X}), and

C_{X}←AEAD (κ_{Link}, s, x), where x is some payload (e.g., a link ID for later reference)

6. X sends (N_{X}, M_{X}, C_{X}) to A.

7. A verifies the MAC M_{X}, derives the link key and uses it to verify and decrypt C_{X}. If either verification fails, A aborts the procedure.

8. A increments the link's sequence counter s←s+1=1, computes the ciphertext:

C_{A}←AEAD(κ_{Link}, s, a)

of some payload a and sends it to X.

9. X verifies and decrypts the message. If this fails, it aborts the procedure.

10. A and X update their link secrets:

[symbol]

_{Link}(A, X)←UpdateSecret( [symbol] _{Link}(A,X)), [symbol] _{Link}(X,A)←UpdateSecret ( [symbol] _{Link}(X,A))

Now both parties use AEAD (κ_{Link}, s, ·) to secure further communication, where s is the sequence counter. initially set to s=0 in step 5, it is incremented for every message. Whenever A sends a request with sequence counter s, it checks that the response's sequence counter is s+1. Otherwise, the link is closed and re-established. Similarly, the link is closed if a decryption attempt fails due to an invalid integrity tag.

Note that a link may be used for asynchronous communication, and responses to multiple requests do not have to arrive in order: A is free to send messages with sequence counters s, s+2, s+4 without waiting for responses in between. When the responses come back, A matches the responses to the requests using either the sequence counters or other means provided by the transport layer. The parties need to close the link if at any point in time a sequence counter is reused, or A receives a response with sequence counter s+1 and it did not send a request with counter s, or if a request and response can be matched by means other than the sequence counter and the response's counter is not the increment of the request's counter.

To avoid race conditions on the sequence counter, A only sends requests, and X sends a single response for each request. If X needs to send a request to A, the parties establish a link with reversed roles for that purpose.

One can serialize sequence counters as 32-bit unsigned integers in little-endian byte order. A link's sequence counter must always be s<2³², otherwise the link must be closed and re-established. (In fact, links should usually be closed much sooner than that.)

Two parties' link secrets can get out of sync if the message sent in step 8 is lost. In this case, only A updates its secret. On the next EstablishLink call, X will resync in step 4.

If both parties are KDHs, they may also switch roles after getting out of sync. To allow resyncing in this situation, an initiating KDH needs to retry EstablishLink calls with a tentatively updated link secret whenever the responding KDH aborts the procedure at step 4, as this may indicate that the KDHs got out of sync before switching roles. If the initiating KDH then receives the message sent in step 6, the retry succeeded, and it must overwrite its link secret by the tentatively updated copy to complete the resync (the secret will proceed to be updated again in step 10).

### 3.3 GetPreKeyData

An endpoint P wants to establish a shared secret with a target endpoint Q. This happens in two phases. First, P requests a PreKeyData object for a connection with Q from the KDN:

P opens a secure connection to a KDH X with which it is associated using EstablishLink (see section 3.2) and sends ID_{Q} to X.

If Q is not associated with KDH X, X identifies a KDH Y, with which Q is associated and opens a secure connection to Y using EstablishLink (see section 3.2). (If such secure connections already exist, they may be reused.) X sends ID_{P} and ID_{Q} to Y. Otherwise, i.e. P and Q are associated with the same KDH, in the following both X and Y refer to that KDH, which performs all subsequent steps itself.

Y derives a base key and computes a MAC over its ID and its key secret's update counter:

S_{y}←KDF( [symbol] _{Key}(Y, Q), “SessionKeyBase”)

M←MAC(κ_{StaticAuth}(Y, Q), ID_{P}||ID_{Y}||n_{KeySecret}(Y, Q))

Using the secure connections, Y sends

PreKeyData_{Y}=(ID_{P}, ID_{Y}, n_{KeySecret}(Y, Q), M)

and the base key S_{Y} back to P. If any connection is closed due to a sequence counter mismatch in the course of delivery of this response, abort the procedure. If the first ID in the returned PreKeyData is not ID_{P}, P also aborts the procedure.

Y rolls the secret:

[symbol]

_{Key}(Y, Q←UpdateSecret( [symbol] _{Key}(Y, Q))

n_{KeySecret}(Y, Q)←n_{KeySecret}(Y, Q)+1

### 3.4 EstablishSessionKey

Once an endpoint P has obtained PreKeyData_{Y} and the base key S_{Y} for a connection with target endpoint Q (via GetPreKeyData (see section 3.3 above)), it can establish a shared session key with Q.

P computes

(E_{PQ}, e_{P})←HybridKexInit(k_{Auth,C}(P), k_{Auth,PQ}(P), K_{Auth,C}(Q), K_{Auth,PQ}(Q))

and sends (E_{PQ}, PreKeyData_{Y}) to Q.

Q verifies the MAC M_{Y} contained in PreKeyData_{Y}. If this fails, it aborts the procedure.

Denote the key secret update counter contained in PreKeyData_{Y} by n, and Q′s own counter n_{KeySecret}(Q, Y) by q. If q≤n, then Q computes for each i∈{q, . . . , n}:

S_{Key,i}(Q, Y)←KDF( [symbol] _{Key}(Q, Y), “SessionKeyBase”)

D_{Y}←D_{Y} ∪{(i, S_{Key,i}(Q, Y))}

[symbol]

_{Key}(Q, Y)←UpdateSecret( [symbol] _{Key}(Q,Y))

and sets n_{KeySecret}(Q, Y)←n+1.

If the tuple tₙ=(n, S_{Key,n}(Q, Y)) is not in D_{Y}, the base key corresponding to the received counter has already been used and Q aborts the procedure. Otherwise, it stores the base key temporarily as S_{Y←SKey,n}(Q, Y) and removes the pair tₙ from D_{Y}.

Q computes the responder's part of the key exchange, derives a confirmation key and computes a MAC: K_{Auth,PQ}(Q)

(E_{QP}, S_{PQ})←HybridKexResp(k_{Auth,C}(Q), k_{Auth,PQ}(Q), K_{Auth,C}(P), K_{Auth,PQ}(P), E_{PQ})

κ_{Conf}←KDF(S_{Y}||S_{PQ}, “ConfirmationKey”)

M_{Q}←MAC(κ_{Conf}, “ConfirmResp”||E_{PQ}||E_{QP})

and sends (E_{QP}, M_{Q}) to P.

P computes

S_{PQ}←HybridKexFinalize(k_{Auth,C}(P), k_{Auth,PQ}(P), K_{Auth,C}(Q), K_{Auth,PQ}(Q), e_{P}, E_{QP})

and derives κ_{Conf}. Using this, it verifies M_{Q}. If the verification fails, P aborts the procedure.

P computes

M_{P}←MAC(κ_{Conf}, “ConfirmInit”||E_{PQ}||E_{QP})

and sends it to Q.

Q verifies M_{P}. If this fails, it aborts the procedure.

Both P and Q can now derive the session key:

κ_{Session}←KDF(S_{Y}||S_{PQ}, “SessionKey”)

Storing unused base keys derived from the shared key secret allows endpoints to handle out-of-order requests while rolling the shared key secret early. In case an endpoint's secrets are leaked at any point in time, the previous instances of the shared key secret as well as the used base keys have already been deleted, maintaining forward secrecy for completed key exchanges.

Symmetric-key re-keying in general has long been an instrument used by cryptographers [13]. Its application towards out-of-order message handling in particular has been adapted from Signal's Double Ratchet algorithm [14].

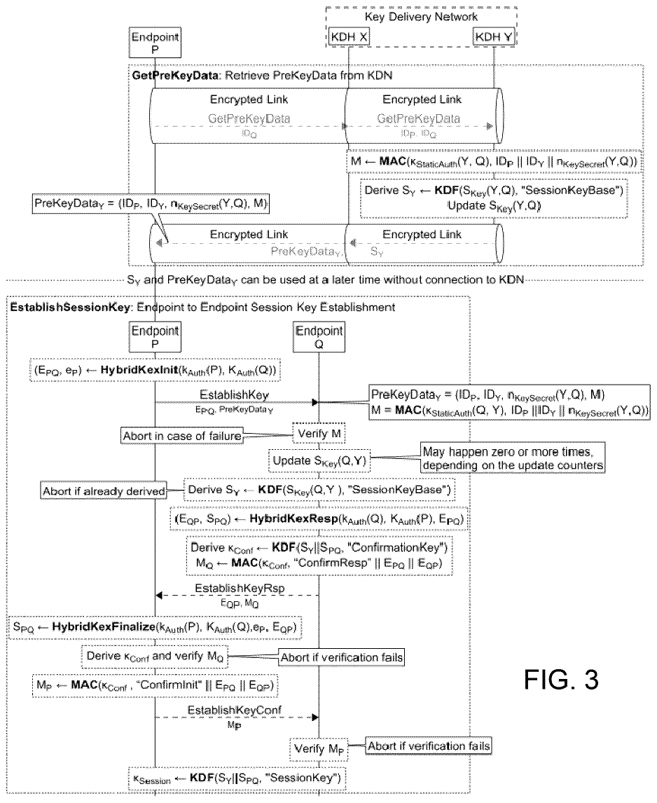

The GetPreKeyData and EstablishSessionKey protocols as discussed above are illustrated in FIG. 3.

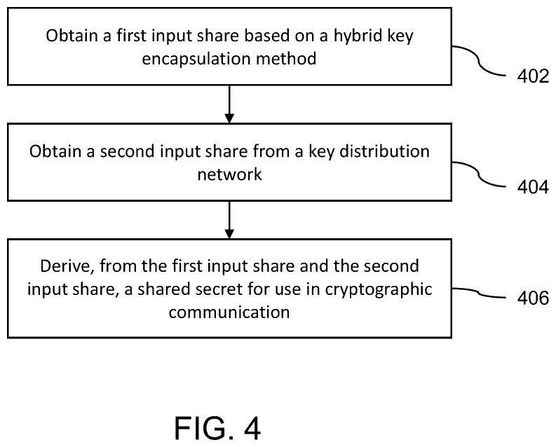

Referring now to FIG. 4, a flow diagram of a method for establishment of cryptographic secrets is shown. At block 402, a first input share based on a hybrid key encapsulation method is obtained. At block 404, a second input share is obtained from a key distribution network. At block 406, a shared secret for use in cryptographic communication is derived based on the first input share and the second input share.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the KDHs, KDN, other device in the system, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order or in parallel, or steps may be added, deleted, or modified.

Although the above principles have been described with reference to certain specific examples, various modifications thereof will be apparent to those skilled in the art as having regard to the appended claims in view of the specification as a whole.

### REFERENCES

[1] D. Boneh, “Twenty years of attacks on the rsa cryptosystem,” Notices of the American Mathematical Society, vol. 46, pp. 203-212, 1999.
[2] B. LaMacchia, K. Lauter, and A. Mityagin, “Stronger security of authenticated key exchange,” in Provable Security (W. Susilo, J. K. Liu, and Y. Mu, eds.), (Berlin, Heidelberg), pp. 1-16, Springer Berlin Heidelberg, 2007.
[3] K. Hovelmanns, E. Kiltz, S. Schage, and D. Unruh, “Generic authenticated key exchange in the quantum random oracle model.” Cryptology ePrint Archive, Paper 2018/928, 2018. https://eprint.iacr.org/2018/928.
[4] L. Chen, “Recommendation for key derivation using pseudorandom functions,” Aug2022.
[5] H. Krawczyk, “Cryptographic extraction and key derivation: The hkdf scheme,” Advances in Cryptology—CRYPTO 2010, p. 631-648, 2010.
[6] E. Barker, L. Chen, and R. Davis, “Recommendation for key-derivation methods in keyestablishment schemes,” Aug 2020.
[7] P. Rogaway, “Authenticated-encryption with associated-data,” Proceedings of the 9th ACM conference on Computer and communications security, 2002.
[8] H. Krawczyk, M. Bellare, and R. Canetti, “Rfc2104: Hmac: Keyed-hashing for message authentication,” 1997.
[9] The keyed-hash message authentication code (hmac),” Tech. Rep. Federal Information Processing Standards Publications (FIPS PUBS) 198-1, U.S. Department of Commerce, Washington, D.C., July 2008.
[10] D. A. McGrew and J. Viega, “The galois/counter mode of operation (gcm),” Jan 2004.
[11] D. A. McGrew and J. Viega, “The security and performance of the galois/counter mode (gcm) of operation,” Progress in Cryptology—INDOCRYPT 2004, p. 343-355, 2004.
[12] M. Dworkin, “Recommendation for block cipher modes of operation: Galois/counter mode (gcm) and gmac,” Nov 2007.
[13] M. Abdalla and M. Bellare, “Increasing the lifetime of a key: A comparative analysis of the security of re-keying techniques,” Advances in Cryptology—ASIACRYPT 2000, p. 546-559, 2000.
[14] T. Perrin and M. Marlinspike, “The double ratchet algorithm,” Nov 2016.

1. A method for establishment of cryptographic secrets, the method comprising:
obtaining a first input share from a key distribution network (KDN); and
obtaining a second input share based on a hybrid key establishment method;
deriving, from the first input share and the second input share, a shared secret for use in cryptographic communication between an initiator and a respondent.

2. The method of claim 1, wherein obtaining the first input share from the KDN comprises:
requesting, by the initiator, a dataset for establishing communication with the respondent; and
receiving a responding dataset from the KDN comprising (1) a base key derived from a pre-existing key secret between the respondent and a hub of the KDN, (2) an update counter and identifiers for the initiator and the hub, and (3) a message authentication code (MAC) authenticating the update counter and the identifiers,
wherein the MAC authenticates via a pre-existing authentication secret shared by the respondent and the hub.

3. The method of claim 2, further comprising rolling the pre-existing key secret, by the respondent, in response to receiving the responding dataset.

4. The method of claim 2, wherein the initiator transmitting the request for the dataset triggers rolling of the pre-existing key secret by the hub.

5. The method of claim 2, further comprising establishing a secure link between the initiator and another hub of the KDN by:
deriving, by the initiator, an authentication secret based on a pre-existing link secret shared by the other hub and the initiator;
transmitting, by the initiator, at least the identifier of the initiator authenticated using the derived authentication secret, the derived authentication secret being able to validate the authenticated identifier transmitted by the initiator;
receiving and confirming subsequent data from the other hub, the subsequent data being validated with the derived authentication secret
deriving a link key to establish the secure link based on the pre-existing link secret for subsequent communication between the initiator and the other hub.

6. The method of claim 5, wherein the hub and the other hub are the same hub of the KDN.

7. The method of claim 5, wherein at least the identifier of the initiator further comprises a nonce, and the subsequent data further comprises a second nonce, and the link key is derived based on the nonce and the second nonce.

8. The method of claim 7, further comprising updating the pre-existing link secret in response to the deriving the link key.

9. The method of claim 8, further comprising using the updated link secret to establish subsequent secure links.

10. The method of claim 5, wherein the established secure link is used for secure asynchronous communication, and the method further comprises employing secure asynchronous communication based on the derived link key and a message counter.

11. The method of claim 1, wherein the initiator and the respondent are both endpoints, the method further comprising:
transmitting, by the initiator, pre-key data received from a hub the respondent is associated with, the transmitted pre-key data being processed by the respondent to obtain the first input;
performing the hybrid key establishment method to generate the second input; and
validating the first input and the second input.

12. The method of claim 11, wherein the respondent is configured to, in processing the pre-key data, to:
update a secret associated with an update counter for communications between the respondent and the KDN; and
compute the first input based on the updated secret.

13. The method of claim 1, wherein the hybrid key establishment method is based on exchanging via both a classical approach and a post-quantum approach.

14. The method of claim 13, wherein the exchange comprises at least two exchanges, and the classical approach and the post-quantum approach exchanges are independent of one another.

15. The method of claim 13, comprising combining secrets resulting from the classical approach and the post-quantum approach to form the resulting hybrid shared secret.

16. The method of claim 11, wherein validating the first and second inputs comprises:
deriving a confirmation key from the first input and the second input; and
confirming, by the initiator, the validity of a message authentication code received from the respondent, the received message authentication code being generated at least in part with the confirmation key;
transmitting, by the initiator, a message comprising a message authentication code generated at least in part based on the confirmation key to enable the respondent to validate the initiator transmitted message authentication code.

17. The method of claim 16, wherein the message authentication code is generated based on outputs of the hybrid key establishment method.

18. The method of claim 12, further comprising storing unused first inputs and deleting used first inputs.

19. A method for associating two entities comprising deriving shared secrets for use in cryptographic communications between the two entities, the method comprising:
based on a common shared base secret, deriving:
a key secret,
a link secret,
an authentication secret.

20. The method of claim 19, wherein the link secret is used to communicate between the entities, and the key secret is used to introduce a third entity known by at least one of the two entities to the other of the two entities, for establishing a shared secret between the third entity and the other of the two entities.

21. A system for cryptographic communications, the system comprising at least two endpoints and a key distribution network comprising a plurality of key distribution hubs connected to one another, at least one of the endpoints comprising a process and memory, the memory storing computer executable instructions that when executed by the processor cause the endpoint to perform operations comprising:
obtaining a first input share from the key distribution network;
obtaining a second input share based on a hybrid key establishment method; and
deriving, from the first input share and the second input share, a shared secret for use in cryptographic communication between an initiator and a respondent.

22. A non-transitory computer readable medium comprising computer executable instructions for cryptographic communications, the computer executable instructions when executed by a processor causing the processor to perform operations comprising:
obtaining a first input share from a key distribution network (KDN); and
obtaining a second input share based on a hybrid key establishment method;
deriving, from the first input share and the second input share, a shared secret for use in cryptographic communication between an initiator and a respondent.
